(19) United States
(12) Patent Application Publication
(10) Pub. No.: US 2005/0127856 A1
(43) Pub. Date: Jun. 16, 2005

(54) Low-voltage electric motors

(75) Inventor: Boris A. Maslov, Reston, VA (US)

Correspondence Address: MORRISON & FOERSTER LLP, 1650 TYSONS BOULEVARD, SUITE 300, MCLEAN, VA, 22102, US

(73) Assignee: WAVECREST LABORATORIES, Dulles, VA (US)

(21) Appl. No.: 10/736,792

(22) Filed: Dec. 17, 2003

Related U.S. Application Data
(63) Continuation-in-part of application No. 10/359,305, filed on Feb. 6, 2003.
(60) Provisional application No. 60/399,415, filed on Jul. 31, 2002.

(51) Int. Cl. H02P 1/18

(52) U.S. Cl. 318/254

(57) ABSTRACT

A distributed architecture for electric motors and generators. This distributed architecture motor can deliver high power at low voltage and low phase current. It works by distributing total current across several “phases,” or electromagnetic circuits of the motor. That creates several advantages. These motors can deliver the high power needed by an electric car at 50 volts or less, which is safer for humans. They improve safety by allowing a motor to operate in an emergency even when one or more phases has a fault. Low voltage motors in electric vehicles allow batteries and fuel cells to have fewer cells. The low voltage and distributed current makes heat easier to handle. The distributed architecture lowers cost by allowing cheaper power electronics to be used. The distributed architecture allows smaller, lighter motors to be made with light wiring, switches and connectors. In addition, it opens the path to lower cost battery and fuel cell technologies, simplified battery and fuel cell management, and wider packaging options.

### CROSS-REFERENCE TO RELATED APPLICATIONS

The present application claims priority from pending U.S. application numbers [the two WCL-171 applications] of Maslov et al., filed Feb. 6, 2003. Both applications are commonly assigned to the same company as the present application and are hereby incorporated by reference in their entirety to this application.

### BACKGROUND OF THE INVENTION

1. Field of Invention

The present invention relates to electric motors that can be used in electric cars and other applications. The present invention also relates to electric generators.

2. Background of the Invention

### Problems with Existing Electric Motors

### Tradeoff between Higher Voltage and Higher Current

It is known that the maximum power (in kilowatts) that can be delivered by an electric motor is equal to the product of the voltage and the current supplied. If the voltage is increased, the current can be decreased without reducing the power delivered. If the voltage is decreased, the current must be increased to supply the same power.

Most large, high-power motors operate at high voltages to reduce the amount of current needed. Using low voltage for a high-power motor would require a larger and heavier electric motor and heavier wiring, switching and contacts to accommodate the very high currents that would be required.

Worse, higher currents quickly lead to lower efficiency, since heat losses due to the resistance of the system increase exponentially. These heat losses (called “copper losses”) increase not just proportionally to the increase in current, but proportionally to the square of the current.

While it is known that higher voltages (i.e., voltages above 50 volts) are dangerous to humans, most stationary motors use higher voltages. Dangerously high voltages are used because most stationary motors are usually operated in a relatively stable environment where the higher voltage is thought to pose relatively little danger.

Electric motors used in mobile applications, such as cars, pose a different problem. For example, the live wires leading to an electric motor used to raise and lower the automobile driver's “power seat” may, in an accident, come into contact with the driver's body. Or the driver, who typically may not be too safety conscious, may get a rude shock when probing under the seat for some lost loose change.

Most of these motors need provide only “fractional horsepower,” or some fraction of one horsepower (746 watts). That means that with the 12-volt battery voltage used in most cars, the current need only be from a few amps to about 60 amps to supply the required power. At 12 volts, these currents may be shocking, but thet are rarely fatal. And these currents are relatively easy to handle using fairly small gauge wires.

Often, though, the tradeoff required by the “power=voltage×current” equation presents problems. For example, high-power electric motors (usually at least 10 kW, but up to 100 kW or more in larger vehicles) are used in electric car and similar applications.

Using a high system voltage (often 200 to 350 volts) presents a safety problem. Using a low-voltage (50 volts or below) motor means dealing with very high currents (often 200 amps or more), which typically requires a large, heavy electric motor and heavy wiring, switching and contacts. Neither choice is appealing.

Or a motor designer may be forced to high voltages by the need to use low currents to meet cost, space or weight constraints. That means a high-voltage (often 200 to 350 volts) power source, which may not be readily available.

For example, a higher system voltage requires a larger number of cells in a battery or fuel cell to be connected in series. That increases the size of the battery or fuel cell stack, complicates energy management, and reduces efficiency. And it may mean using higher-priced components that can handle high voltages. Here again, neither choice is appealing.

A motor architecture that can be used to make higher power electric motors using a lower system voltage (for example, 50 volts or less) together with lower currents (for example, 100 amps or less) would give motor designers a much better choice. But such a motor architecture would seem to violate the known physical law that “power is equal to voltage times current.”

### The Safety Problem of High System Voltage for Electric Car Motors

The high voltages required by high-power electric motors present a particular problem with electric cars. Electric motors appear in the power train of an increasing number of cars every year. “Pure” electric cars powered only by electric motors remain rare. But “parallel hybrid” electric cars powered by both a gasoline engine and an electric motor have started to make an impact on the market.

Toyota and Honda led the car market into the production of hybrid cars with the Toyota Prius and the Honda Insight and Hybrid Civic. Those cars sold well, although at a highly subsidized price tag. It is believed that Ford and GM will follow Toyota and Honda into the hybrid market in 2003 or soon thereafter.

Efficiency drives the push toward having an electric motor in the power train of a car. An electric motor in tandem with a gasoline engine can produce higher gas mileage than existing gasoline cars. The Honda Hybrid Civic may get as much as 50% better gas mileage than the standard, gasoline model.

Many of today's cars are engineered to be very fuel-efficient. But consumers like high-powered sports/utility vehicles (SUVs). That has caused the average gas mileage of the cars on American roads to decrease in recent years. That has been the case, even though carmakers continue with their efforts to make more fuel-efficient cars in some of their models.

Governments pressure carmakers to increase the average gas mileage of the cars they sell. Fuel efficiency is easier with a small four-cylinder engine. Making a fuel-efficient V6 or V8 engine providing two or three hundred horsepower is much harder. One way for carmakers to do that is by adding electric motors to the popular SUVs. That way, they can continue to get the high prices that consumers are willing to pay for SUVs, and avoid conflict with government regulators.

Most motor designers use high voltage to get the high power required by electric vehicles. The Honda Insight (a small two-seater) has a 144-volt system for its engine assist motor. The Toyota Prius (a five-seater, although quite small) has a 288-volt system for its motor, although its new model appears to bring the voltage down to 144 volts. But these are smaller cars. Electric motors for large SUVs may have to double these voltages to generate the high power required.

These voltages present a significant safety problem. Any voltage above 50 volts from a low impedance source can give a potentially fatal electric shock to a human. If there is a low-resistance connection between a person, the electricity source, and the ground, at these voltages enough current may flow through his or her vital organs to cause death.

For example, if a car crash pinned a driver into contact with a live electric wire from the high-voltage battery system, he or she may well die from electric shock even after surviving the crash. For these reasons, government regulations typically require special safety measures to be taken for system voltages over 50 volts.

And in an AC system 50 volts peak level corresponds to only 35 volts RMS (or actual power, which is the square root of 2 times peak voltage for a sinusoidal waveform). That makes keeping an intrinsically safe voltage level even more difficult in an AC system. In practice, an electric vehicle operating with a 50-volt system would require a large and heavy electric motor and heavy wiring, switching and contacts to accommodate the very high currents that would be required.

To avoid this and to permit the use of much lighter-weight components, with existing motor architectures many designers use voltages up to 350 volts in cars and up to 500 volts in commercial electric vehicles. When these higher voltages are used, great care must be taken to insulate all cables and connectors from any possibility of contact by drivers or service personnel.

In addition, great care has to be taken to protect these cables and connectors from any contact in a crash. The electrical system is usually isolated from the vehicle chassis. That allows any “short-to-chassis” anywhere in the system to be detected. Then the system shuts down by protective devices that protect the driver, passengers, and firefighters or other emergency personnel as far as is possible under an emergency procedure.

Isolating the electrical system from the chassis also reduces the danger to operators or service personnel if accidental contact should take place. That way, the point in the system where the contact is made becomes the only point on the system at the same potential as the person or object making the connection.

Finally, designers also often provide interlocks so that high-voltage circuits are disconnected whenever vehicle compartments containing these circuits are opened. All of these measures can reduce the danger of high voltages.

However, these measures also add to the cost and complexity of the vehicle. Moreover, in spite of all these measures, accidents still happen. A large amount of energy is stored in a charged electric vehicle battery (as it is in a tank of gasoline). Any short-circuit which does occur in an accident may result in a major release of this energy, and a consequent explosion and fire. The higher the battery system voltage, the greater the danger.

All things considered, a lower system voltage appears to be a better way to protect against the dangers of electrical shock. Unfortunately, though, no existing electric motor system provides the higher power needed to move an automobile while keeping the system voltage at 50 volts or less.

### Other Issues with the Voltage/Current Tradeoff

Using a high battery-system voltage can have some benefits on the power electronics—current is reduced and related losses due to voltage drops in the power elements may be reduced. However, safety and other considerations can limit the voltages used.

For example, as discussed above safety concerns limit the range of voltages used in most electric cars to between 200 volts and 350 volts, although there have been proposals to use over 500 volts for special vehicles. Even limiting the voltages to those levels causes great safety concerns.

Other considerations may limit the system voltage of an electric motor. For example, cost may be an issue in some applications. That may lead to the choice of MOSFETs, which are cheaper than IGBTs and offer better performance.

Despite MOSFETs' advantages, they have been considered inappropriate for high-voltage electric motors used in electric cars. The MOSFET's relatively low voltage capability and the need to operate a number in parallel to obtain the current output required for electric vehicle operation often made them a high-cost option. The general consensus has been that MOSFETs cannot effectively meet the combination of low “on” resistance and high-voltage capability required for electric car motors.

Rather than using MOSFETs, the conventional wisdom has been that the desired parameters can be more cheaply and easily met by using IGBTs. IGBTs can handle higher voltages than MOSFETs. But at voltages where MOSFETs can be used, IGBTs provide poorer performance and at an increased cost. Although the difference in cost can be large, IGBTs and other high-cost, high-voltage power electronics have been used in almost all electric car motor systems.

High voltages can also be more difficult to deliver, particularly from batteries or fuel cells. Typically, each cell in a battery or fuel-cell stack provides a relatively low voltage. Most current battery technologies have single cell voltages of between 1.2 volts (for example, nickel cadmium) and 3.6 volts (lithium ion). Hundreds of cells must be assembled and connected to provide a system voltage of 200 to 350 volts. That makes for a large battery with hundreds of electrical connections between cells.

Fuel cells are similar. The typical proton-exchange membrane (PEM) fuel cell produces electricity at between 0.6 and 0.7 volts. That requires at least 350 cells in a stack to produce a reasonable system voltage of 250 volts. As a result, at least 350 gas and electrical connections must be made to connect all the cells. A smaller stack requires fewer connections, and thus can be simpler, less costly and more reliable.

The number of cells also affects the size and shape of the fuel cell. The height of the typical fuel cell stack makes it difficult to find a place for it in an electric vehicle. Development has reduced the size of both the fuel-cell stack and the reformer for turning various fuels into hydrogen. Electric carmakers can now consider housing the assembly beneath the floor of the vehicle, giving room for four seats and reasonable luggage space. But with a high system voltage, that may be impossible.

Even voltages less than 50 volts require changes from the normal 12-volt system used in most modem cars. Connectors certainly will need redesigning, because disconnecting loads from a running system, which causes only brief sparks at 12 volts, can cause sustained arcing at 42 volts, and so erode contacts and even start fires. Imagine the problems with 350 volts.

Heat also becomes a bigger problem with high voltages and high currents. Any motor loses some power due to resistance in the wire windings. Unless superconducting wires are used, there will always be power dissipated in the form of heat through the resistance of the current-carrying conductors.

As the current increases, the heat losses due to the resistance of the system increase proportionally to the square of the current. Thus, heat losses increase exponentially. The long lengths of wire in an electric motor can make these losses a significant factor. Increasing the gauge of the winding wire is one way to minimize these losses, but only with substantial increases in cost, size, and weight.

The power electronics and other semiconductor components of a high-power electric motor also dissipate a considerable amount of heat, making a substantial heat sink necessary. The voltage drops across the semiconductor devices when conducting will therefore be an important factor in the selection of suitable devices. Keeping those voltage drops low will also be important in reducing heat and its drag on efficiency.

Higher currents can also be a big drag on efficiency. System efficiency decreases as the amount of energy put out as heat increases. As noted above, these so-called “copper losses” that cause much of the heat loss increase not linearly, but exponentially, as current increases. So keeping currents and voltages low can greatly help improve efficiency.

Motor designers are familiar with the disadvantages of using high currents in a motor. The number of turns in a motor's windings is critical to the amount of torque produced. With high current, large gauge wires are required to avoid melting the wires. Making a motor that requires a large number of turns of large gauge wire can be a nightmare.

So high current requires a large and heavy electric motor and heavy wiring, switching and contacts to generate the desired power. Apart from the size and weight issues this brings, the cost and manufacturability of a high current motor are often impracticably high.

For all the reasons discussed above, the controls (including power electronics) for a high-power electric car motor make up a large, complex, heavy, expensive system. The wires, semiconductors and other components have to handle high voltages and high currents. They generate lots of heat, requiring heat sinks and cooling. All of this increases cost and reduces efficiency.

The workhorse of existing electric motors is the three-phase AC induction motor. The power electronics for these motors are generally connected in either a “Y” or a “Δ” (“delta”) configuration.

Often the following terminology is used for these motors. First, the conductors connected to the three points of a three-phase source or load are called “lines.” The three components comprising a three-phase source or load are called “phases.”

“Line voltage” is the voltage measured between any two lines in a three-phase circuit. “Phase voltage” is the voltage measured across a single component in a three-phase source or load.

“Line current” is the current through any one line between a three-phase source and load. “Phase current” is the current through any one component comprising a three-phase source or load.

Using these definitions, in balanced “Y” circuits, line voltage is equal to phase voltage times the square root of 3, while line current is equal to phase current.

For “Y” circuits:
Eₗᵢₙₑ=\sqrt{3}Eₚₕₐₛₑ
lₗᵢₙₑ=lₚₕₐₛₑ

In balanced “Δ” circuits, line voltage is equal to phase voltage, while line current is equal to phase current times the square root of 3.

For Δ (“delta”) circuits:
Eₗᵢₙₑ=Eₚₕₐₛₑ
lₗᵢₙₑ=\sqrt{3}lₚₕₐₛₑ

The two different connection types have different advantages. For example, “Δ”-connected three-phase voltage sources give greater reliability in the event of winding failure than “Y”-connected sources. However, “Y”-connected sources can deliver the same amount of power with less line current than “Δ”-connected sources.

A motor control system that need handle only 50 volts or less, and currents in each electromagnetic circuit of 100 amps or less, could be much smaller, simpler, lighter and cheaper than existing systems. In addition, the lower system voltage would be safer, and the lower peak current would allow use of smaller, lighter, cheaper wires, switches and switching electronics, connections, and the like.

To overcome the shortcomings of the prior art, it is therefore desirable to provide a distributed architecture for electric motors that can deliver higher power at relatively lower system voltage and with the combination of several distributed low currents. Such a low-voltage motor has the potential to deliver many advantages over existing motor architectures.

A distributed architecture enables lower system voltage requirements and a combination of several distributed low-peak currents. A cascade effect follows. First, the lower voltage (for example, under 50 volts) enhances human safety. Second, lower cost power electronics can be used. Third, industry-standard connectors, conductors, and circuit protection can be used. The custom-designed, heavy-duty versions often required for electric vehicles can be avoided. Fourth, the architecture opens the path to lower cost battery and fuel cell technologies, simplified battery and fuel cell management and wider packaging options.

In particular, low-voltage motor systems enable a power battery to deliver higher performance. First, fewer cells in series provides better cell balance, and more robust performance. Second, simpler thermal management and voltage control reduce peripheral cost, weight and energy losses.

Third, batteries with lower-cost chemistries become possible (lead-acid or nickel metal hydride instead of lithium ion) at a higher safety factor. Fourth, low-system voltage reduces battery fade and losses in power electronics.

Specifically, the advantages of lower voltage include the following. Cheaper power electronics can be used. (For example, MOSFETs can be used instead of IGBTs.) The motor generates less heat (as long as phase current does not increase). Fewer battery cells are needed, and fuel cell stacks can be shorter. Human safety can be assured without the additional expense of a passenger protection system.

Specifically, the advantages of lower current include the following. Batteries last longer between charges. Smaller gauge wires can be used. This results in lighter wiring, switches and contacts.

In short, a motor architecture such as a distributed motor architecture, has the following advantages: reduced cost, reduced weight, reduced risk of danger for humans, and decreased impact of possible malfunctions.

There may be some disadvantages to this distributed architecture, as well. Because power is equal to voltage times current, higher voltage requires less current to generate the same power. High current drain is one of the primary factors in reduced battery, motor and controller life.

Because of the distributed design of the low-voltage motor, motor and controller life should not be affected, and because the low system voltage may require higher currents to be used in this distributed design than in a traditional design, battery issues may continue to be a problem.

In a low-voltage motor, with its distributed architecture, the total current required by the system to produce a given power must be produced by the power source. Even though it is distributed over a large number of electromagnetic circuits, the total current required across the motor system will always be higher than with a higher system voltage design.

Even with a distributed design, the power source for a low-voltage motor in accordance with the present invention will need to provide more current than with a higher-voltage design. But many of the disadvantages that come from low-voltage designs may be avoided with a distributed design.

For example, it may be possible to avoid using larger gauge wires. If the power sources are distributed as well as the currents, with a separate power source for each phase of a motor, the line current will never exceed the distributed phase current. Thus, the wires carrying the line current need be no larger than the wires carrying the phase current.

An electric car powered by four in-wheel motors, having fifteen independent sets of power electronics for each of four motors may allow the electric car's motor system to deliver high power at a low system voltage with relatively low individual currents. In such an example, the four-motor system may provide total system power of 68 kW at a system voltage of 42 volts with peak in-motor current of about 27 amps.

In another example, five independent sets of power electronics for each of the four motors each could energize a group of three windings. In this example, the four-motor system might provide a total system power of 68 kW at a system voltage of 42 volts with peak in-motor current of about 81 amps.

For comparison, a typical electric motor for an electric vehicle that delivers comparable power would have a system voltage of at least 200 volts, and more likely 350 volts or more. The total peak current would be almost 400 amps for a system voltage of 200 volts, and about 225 amps for a system voltage of 350 volts. These voltages are dangerous to humans, and these currents require heavy-duty power electronics (likely IGBTs instead of MOSFETs) and large wires.

One might design a conventional electric motor to operate at a system voltage of 50V, which is relatively safe for humans. Such a design, however, would require a large and heavy electric motor and heavy wiring, switching and contacts to accommodate the very high currents (perhaps 1,500 amps) that would be required. It is simply impractical.

By contrast, operating four in-wheel distributed motors at a system voltage of 50 volts might require less than 100 amps peak phase currents to provide a reasonable 68 kW of power. Such a difference in system voltage and peak current can affect many different aspects of the motor and battery or other power system.

### SUMMARY OF THE INVENTION

### BRIEF DESCRIPTION OF THE DRAWINGS

One or more examples of an adaptive electric car are shown in the drawings. A brief description of each drawing follows:

FIG. 1 shows an example of the basic physical structure of a motor in accordance with the present invention. [Figure showing the Gamma motor structure with 15 independent phases.]

FIG. 2 shows an example, in block diagram form, of a motor in accordance with the present invention with a separate power source and a separate set of power electronics for each of fifteen stator windings. [Figure showing the Gamma motor with each group having its own power source and power electronics.]

FIG. 3 shows an example of a basic physical structure of a motor in accordance with the present invention. [Figure showing the Alpha motor with 7 independent phases.]

FIG. 4 shows an example, in block diagram form, of a motor control system in accordance with the present invention. [Use FIG. 16 from the comprehensive patent application.]

FIG. 5 shows an example, in block diagram form, of power electronics that energize the stator windings in groups of three. [Attached at end of this document.]

FIG. 6 shows an example of switching circuitry for each set of stator windings in a motor in accordance with the present invention.

FIG. 7 shows an example, in block diagram form, of a distributed motor in accordance with the present invention.

FIG. 8 shows an example of an electric car in accordance with the present invention with four motors and four batteries/controls.

### DETAILED DESCRIPTION OF THE INVENTION

The present invention provides a distributed architecture for electric motors and generators. These motors deliver high power while operating at low voltage and a combination of several distributed low currents. These generators deliver high power with [low voltage potential across the generator phases??].

This architecture distributes the total current across several “phases,” or electromagnetic circuits, of the motor. That allows the motor to produce high power even though the system voltage remains low and the current in each electromagnetic circuit also remains low. That creates several advantages.

A distributed motor architecture, with its lower voltage, improves human safety. In an electric car, motors in accordance with the present invention can deliver higher power at 50 volts or less, which will eliminate the risk of a fatal shock even in an accident. Existing electric car motors typically operate at much higher and more dangerous voltages.

A motor with distributed architecture in accordance with the present invention also improves safety by providing extra fault tolerance. In an emergency, a motor in accordance with the present invention can continue to operate even when one or more electromagnetic circuits of the motor break down.

In cases where a battery or fuel cell is used (such as in an electric car), a motor in accordance with the present invention that operates at a lower system voltage allows the battery or fuel cell to have fewer cells. The lower voltage and distributed current make heat easier to handle, since the heat can dissipate easier when it is not so concentrated. And with lower current in each phase, less heat is generated.

The distributed architecture in accordance with the present invention lowers cost by allowing cheaper power electronics to be used. It also allows smaller, lighter motors to be made with light wiring, switches and connectors. In addition, it opens the path to lower cost battery and fuel cell technologies, simplified battery and fuel cell management, and wider packaging options.

The two tables below give some examples of power, voltage and current parameters for various motors. These examples show some of the difference between a distributed motor in accordance with the present invention and existing three-phase AC induction motors, both “Y”-connected and “Δ”-connected.

Each table includes for comparison the power, voltage and per-phase current curves for conventional, “Δ”-connected and “Y”-connected three-phase AC induction motors of the same rated power. Note that the line current for the “Δ”-connected motor is the peak per-phase current multiplied by the square root of 3. Similarly, the line voltage for the “Y”-connected motor is the per-phase voltage multiplied by the square root of 3.

Note also the conversion between V_{RMS} and A_{RMS} and peak voltage and amperage. The conversion done here assumes a pure sinusoidal waveform for both voltage and current, and thus the conversion is multiplication by the square root of 2.

TABLE 1

| | | | | | Peak | Peak | |
|---|---|---|---|---|---|---|---|
| | | | | Peak | Line Current | Line Current | Peak |
| | Peak | Per-Phase | Line | Per-Phase | (A) (separate | (A) (single | System |
| | Power | Voltage | Voltage | Current | power source | power source | Current |
| Motor Type | (kW) | (V) | (V) | (A) | per phase) | per motor) | (A) |
| 68 kW 3- | 68 | 143 (V_{RMS}) | 350 | 223 (158 A_{RMS}) | Not | 223 | 223 |
| phase AC | | | | | applicable | | |
| induction | | | | | | | |
| (Y-connected) | | | | | | | |
| 68 kW 3- | 68 | 141 (V_{RMS}) | 200 | 227 (161 A_{RMS}) | Not | 392 | 392 |
| phase AC | | | | | applicable | | |
| induction | | | | | | | |
| (Δ-connected) | | | | | | | |
| 68 kW 3- | 68 | 82 (V_{RMS}) | 200 | 392 (276 A_{RMS}) | Not | 392 | 392 |
| phase AC | | | | | applicable | | |
| induction | | | | | | | |
| (Y-connected) | | | | | | | |
| 68 kW 3- | 68 | 21 (V_{RMS}) | 50 | 1526 (1079 A_{RMS}) | Not | 1526 | 1526 |
| phase AC | | | | | applicable | | |
| induction | | | | | | | |
| (Y-connected) | | | | | | | |
| 68 kW 4-motor | 68 | 42 | 42 | 27 | 27 | 405 | 1620 |
| system with 15 | | | | | | | |
| independent | | | | | | | |
| phases, | | | | | | | |
| distributed | | | | | | | |
| architecture | | | | | | | |
| 68 kW 4-motor | 68 | 42 | 42 | 81 | 81 | 405 | 1620 |
| system with 15 | | | | | | | |
| independent | | | | | | | |
| phases, | | | | | | | |
| distributed | | | | | | | |
| architecture | | | | | | | |

TABLE 2

| | | | | | Peak Line | Peak Line |
|---|---|---|---|---|---|---|
| | | Per- | | | Current (A) | Current (A) |
| | Peak | Phase | Line | Peak | (separate | (single power |
| | Power | Voltage | Voltage | Per-Phase | power source | source per |
| Motor Type | (W) | (V) | (V) | Current (A) | per phase) | motor) |
| 1 kW 3-phase | 1,000 | 15 V_{RMS} | 36 | 31 (22 A_{RMS}) | Not applicable | 31 |
| AC induction | | | | | | |
| (Y-connected) | | | | | | |
| 1 kW 3-phase | 1,000 | 26 V_{RMS} | 36 | 18 (13 A_{RMS}) | Not applicable | 31 |
| AC induction | | | | | | |
| (Δ-connected) | | | | | | |
| 1 kW motor | 1,000 | 36 | 36 | 2 | 2 | 28 |
| with 7 | | | | | | |
| independent | | | | | | |
| phases, | | | | | | |
| distributed | | | | | | |
| architecture | | | | | | |

That a distributed motor operates at lower voltage and lower current than conventional designs provide great advantages in lower cost, lighter weight, and easier manufacturability. There are other advantages as well.

For example, each cell or layer in a fuel cell stack typically delivers a fairly low voltage (perhaps 0.7 volts). That requires at least 350 cells in a stack to produce a reasonable system voltage of 250 volts. With the 42 volts of the distributed motor design, about 60 cells will suffice. That may allow a fuel cell stack to be placed out of the way, for example, under the floor of a car rather than intruding into the passenger compartment.

A lower system voltage and lower currents in the electromagnetic circuits will also help in many motor designs to avoid issues with heat buildup. As noted above, heat becomes a bigger problem with high voltages and high currents. As the current increases, the heat losses due to the resistance of the system increase proportionally to the square of the current. Thus, heat losses increase exponentially.

The present invention, with lower currents, may reduce the heat that becomes a bigger problem with high voltages and high currents. As the current decreases, the heat losses due to the resistance of the system decrease proportionally to the square of the current. Lower currents in each electromagnetic circuit can significantly reduce heating.

Lower currents can improve efficiency. System efficiency increases as the amount of energy put out as heat decreases. Here again, these so-called “copper losses” that cause much of the heat loss increase not linearly, but exponentially, as current increases. As current decreases, heat losses also decrease exponentially.

The fact that the currents are distributed across the motor electromagnetic circuits may also help distribute the heat. If cooling is still needed, the distributed motor design may often facilitate cooling.

A motor with distributed architecture also improves safety by providing extra fault tolerance. In an emergency, a motor can continue to operate even when one or more electromagnetic circuits of the motor break down.

In an existing three-phase electric car motor with a “Y”-connected system, a fault in one circuit makes the whole motor stop. An existing motor with a “Δ”-connected system can have one of its windings fail open without affecting load voltage or current. However, if only two phases in a three-phase AC induction motor are operating, the torque provided by the motor will be so unbalanced that the motor will operate very poorly, if at all.

Using new soft magnetic composites and other new materials in these low-voltage motors can bring additional advantages. Incorporation of high-tech materials in these motor designs reduces motor weight and battery power requirements. High efficiencies and reduced heating result in reduced battery charging and downtime of electric vehicles.

Of course, the laws of physics still apply. To get 68 kW of total power from the motor system, the system voltage times the total current required across the four-motor system will still need to equal 68,000. But since the current is distributed, the individual phase currents are still low. This is a big advantage, with the only disadvantage being the need for additional wiring. But clearly some real advantages come from the distributed motor architecture.

The low-voltage motor architecture in accordance with the present invention, while still bound by the laws of physics, allows a low system voltage together with relatively low peak phase currents to produce high power. To comply with the law of physics that says that power is equal to voltage times current, the present invention may require the use of more components than existing motor architectures, which may cause problems with cost or size constraints.

In most applications, though, the additional components required are relatively cheap. Size issues can also often be resolved by the motor architecture in accordance with the present invention. That allows the advantages of both low voltage and low phase (and perhaps even line) current to be realized. Those advantages may be very big.

A disadvantage of the distributed architecture may be the complexity of the controller. Implementing the controller in software can help overcome this disadvantage. The distributed architecture may also require more wiring and other components than traditional designs. In most cases, though, the advantages brought by the distributed architecture greatly outweigh the cost of additional wires and other components.

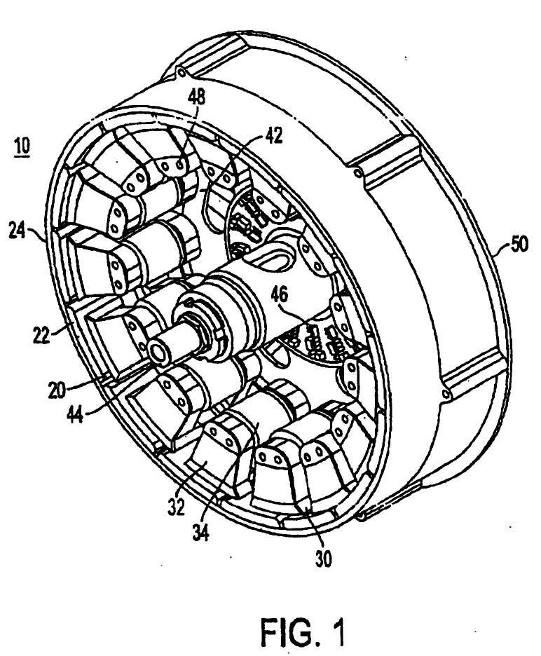

An example of a “brushless DC” motor in accordance with one embodiment of the present invention is shown in FIG. 1. Four such in-wheel brushless DC motors could be used to power an electric car. In this example each of the four in-wheel motors could deliver peak power of 17 kW, for a total peak system power of 68 kW.

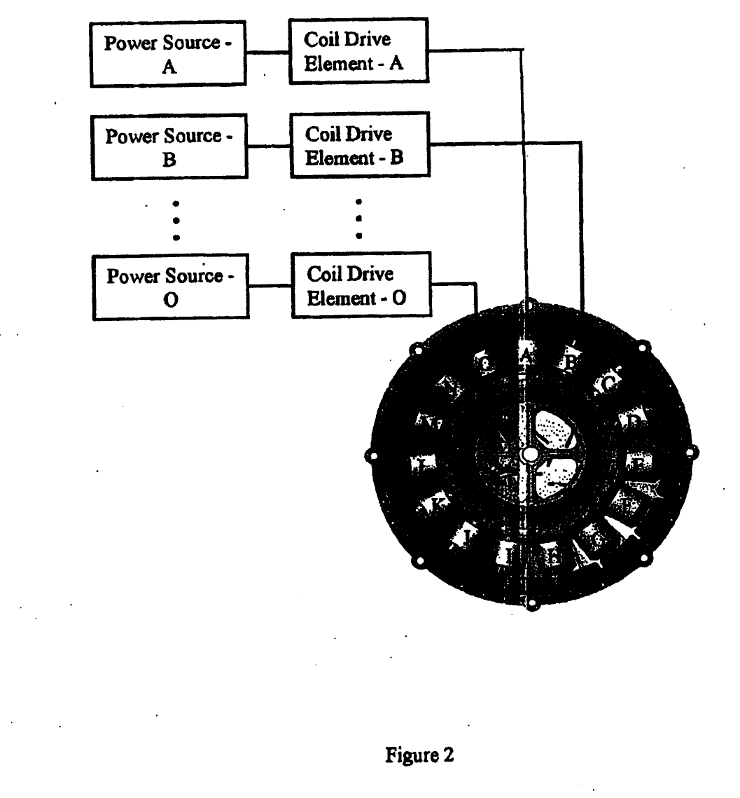

FIG. 2 shows an example, in block diagram form, of a motor in accordance with the present invention. In the example shown in FIG. 2 there are fifteen separate power sources A-O. Each power source may comprise, for example, a battery, a fuel cell, a generator, or any other source of electricity. In one preferred embodiment each power source may comprise a model number battery, manufactured and sold by the ______ company, which battery is designed to provide a voltage of ______ at a current rating of ______.

As further shown in FIG. 2, each one of the fifteen power sources A-O is electrically connected to a corresponding coil drive element A′-O′. Each coil drive element A′-O′ may comprise, for example, a ______. In one preferred embodiment each coil drive element may comprise a ______ made by the _____ company. In the illustrated embodiment, each coil drive element A′-O′ performs the function of ______.

Again referring to FIG. 2, each coil drive element A′-O′ is electrically connected to a corresponding one of fifteen stator windings A″-O″ in the motor ______. The motor ______ thereby has fifteen independent electromagnetic circuits, or “phases,” each one of which has a separate, electrically independent power source. The absence of electrical connection among the circuits enables a lower line current between the power sources and the electromagnetic circuit. Electrically isolating each of the fifteen electromagnetic circuits substantially reduces or eliminates electrical and electromagnetic interference among the electromagnetic circuits. This, in turn, enables more precise control over the flow of current within each electromagnetic circuit.

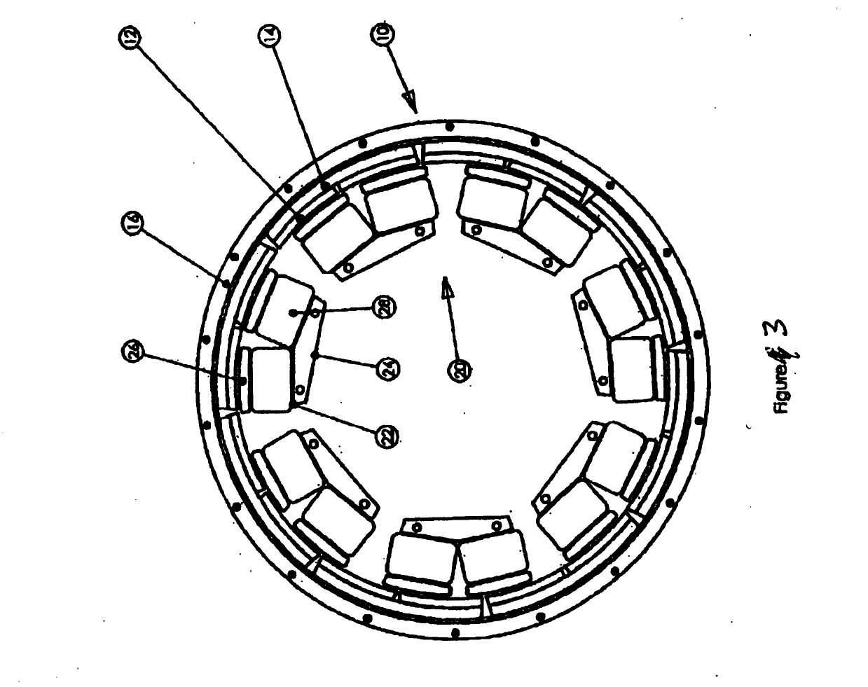

FIG. 3 shows an example of another motor in accordance with the present invention. The illustrated example shows a one kilowatt motor with seven independent, isolated phases. With a system voltage of 36 volts, the peak per-phase current in this example is a low 2 amps.

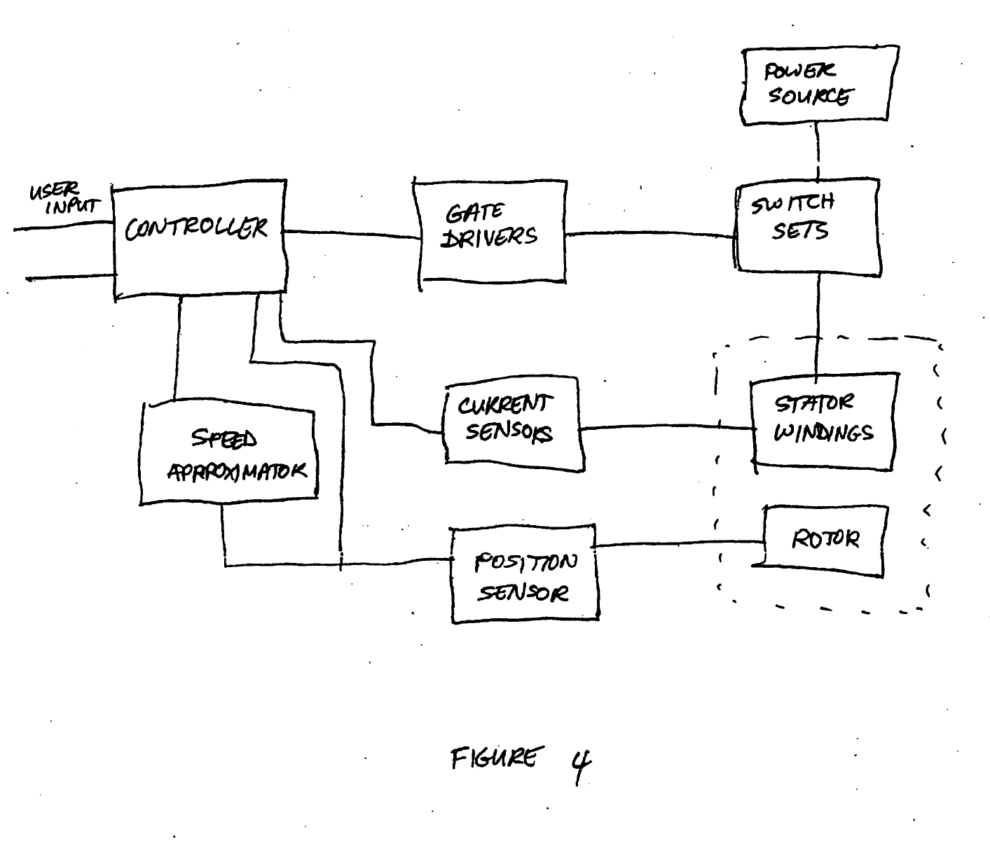

FIG. 4 shows an example, in block diagram form, of a motor control system in accordance with the present invention. In this example, the motor (?) has five (?) independent sets of power electronics. A single motor controller ______ controls five independent, isolated sets of power electronics, each set driving a “phase,” or group of three stator windings.

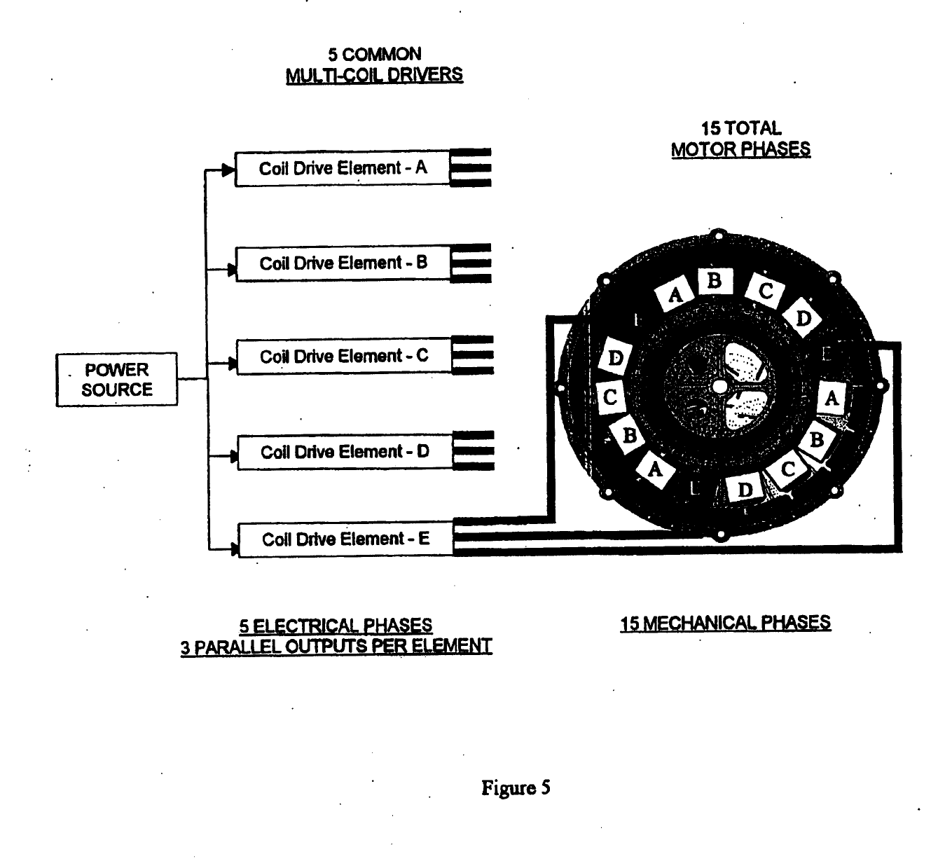

FIG. 5 shows an example, in block diagram form, of a group of five power electronics, each of which energizes a group of three stator windings. The direction and the amount of the current flowing through the stator windings are switched by the power electronics.

Using pulse width modulation, the voltage and current flowing through the stator windings can be varied to produce electromagnetic forces of a desired strength and polarity. The electromagnetic forces produced by the stator windings interact with the magnetic forces created by the permanent magnets on the rotor to make the rotor turn.

The examples described above are only a few representative examples in accordance with the present invention. The present invention should not be limited to the examples described here, or limited to motors used in electric cars, or even limited to motors. Instead, the low-voltage motor architecture described here can be applied to many different types of motors, used for many different applications, and to generators and possibly other types of electric machines.

### Power Electronics

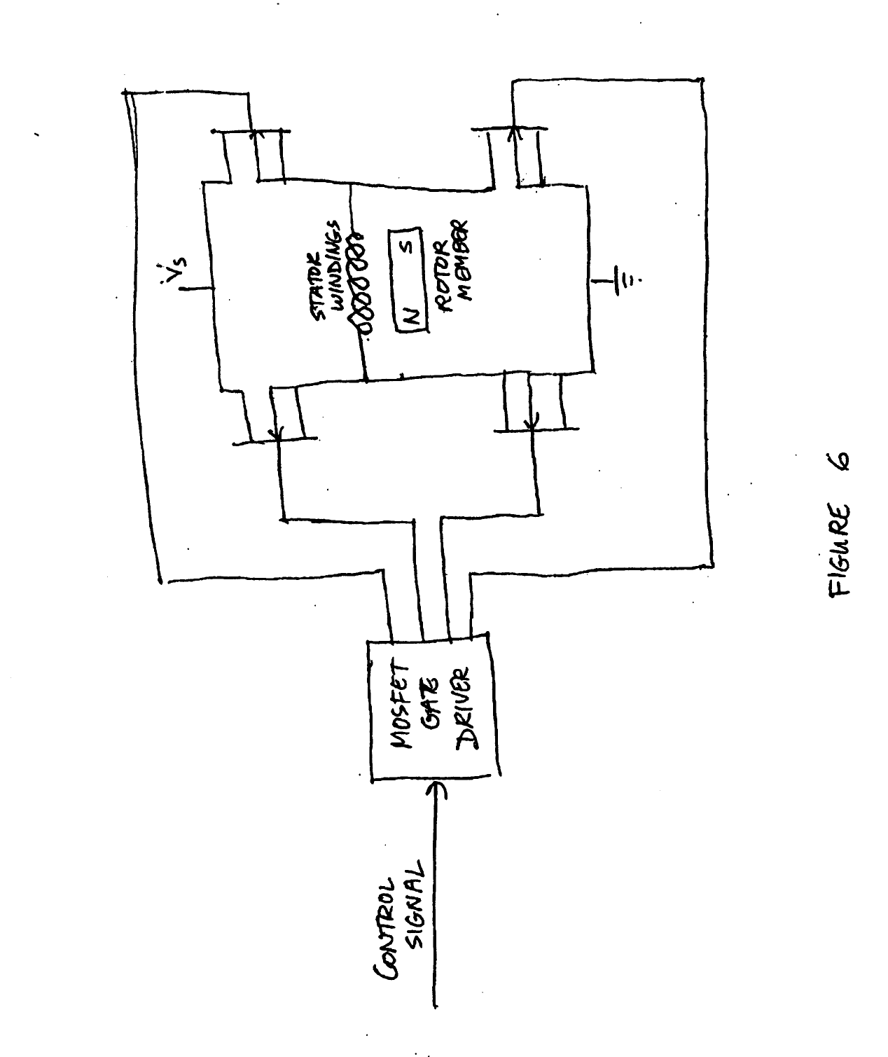

FIG. 6 shows an example of a partial circuit diagram of a switch set and driver for an individual stator winding. In the example illustrated in FIG. 6, four MOSFETs acting as a switch set connect each stator winding in a bridge circuit. Electronic switches energize the motor windings in this example, as is well known in the art.

A MOSFET bridge circuit can shape the voltage and current used to energize the stator windings. This can be done by pulse width modulation, a technique well known in the art. A digital signal processor (DSP) or other microprocessor generates the control signal to drive the MOSFETs.

The bridge circuit for pulse width modulation may be a full or a half bridge circuit. While a four-MOSFET switch set is shown here, any of various known electronic switching elements may be used to provide driving current in the appropriate direction to the stator windings.

FIG. 3 shows an example in which there are five sets of power electronics, with each set driving three separate stator windings. For a motor having fifteen stator windings, the number of sets of power electronics may be any number that is a factor of 15. FIG. 2 shows an example in which there are fifteen sets of power electronics for a fifteen-stator pole motor. Fifteen sets of power electronics would give the most independent parameters to optimize, but may also be the most costly. The example shown in FIG. 3, in which there are five sets of power electronics, may provide an acceptable compromise between cost and complexity on the one hand and ability to optimize on the other.

In the example shown in FIG. 5 a control signal controls the MOSFET gate driver, which in turn drives the MOSFET switch set. The MOSFET switch set sends the driving current (shown as V_{S}) through the stator winding in the appropriate direction.

FIG. 6 shows an example of switching circuitry for a set of stator windings. The motor controller varies the amount of voltage and current being sent through each stator winding using pulse width modulation. Thus, the motor is driven by varying both the amount of voltage and current being sent through the stator winding and the direction of the current.

In the example of FIG. 2, fifteen independent sets of power electronics for each of four motors allows the electric car's motor system to deliver high power at a low system voltage with relatively low current. In this example, the four-motor system provides total system power of 68 kW at a system voltage of 42 volts with peak current of about 28 amps.

In the example of FIG. 3, five independent sets of power electronics for each of four motors allows the electric car's motor system to deliver the same high power at the same low system voltage, but with more current. In this example, the four-motor system provides total system power of 68 kW at a system voltage of 42 volts with peak current of about 81 amps. That the number of sets of power electronics in this example is smaller than in FIG. 2 may bring cost, size and weight advantages, at the expense of higher current and less freedom to optimize.

For comparison, a typical electric motor for an electric vehicle that delivers comparable power would have a system voltage of at least 200 volts, and more likely 350 volts or more. The peak current would be almost 400 amps for a system voltage of 200 volts, and about 225 amps for a system voltage of 350 volts.

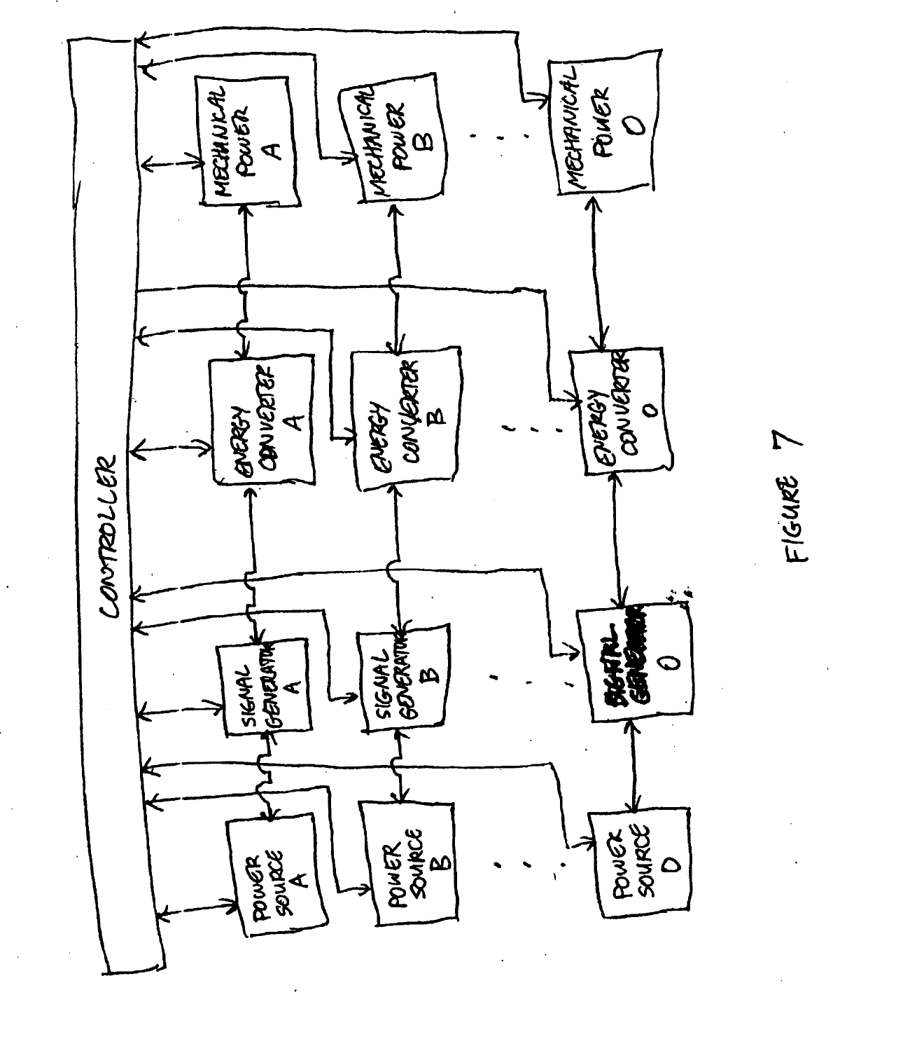

FIG. 7 shows an example, in block diagram form, of a distributed motor in accordance with the present invention.

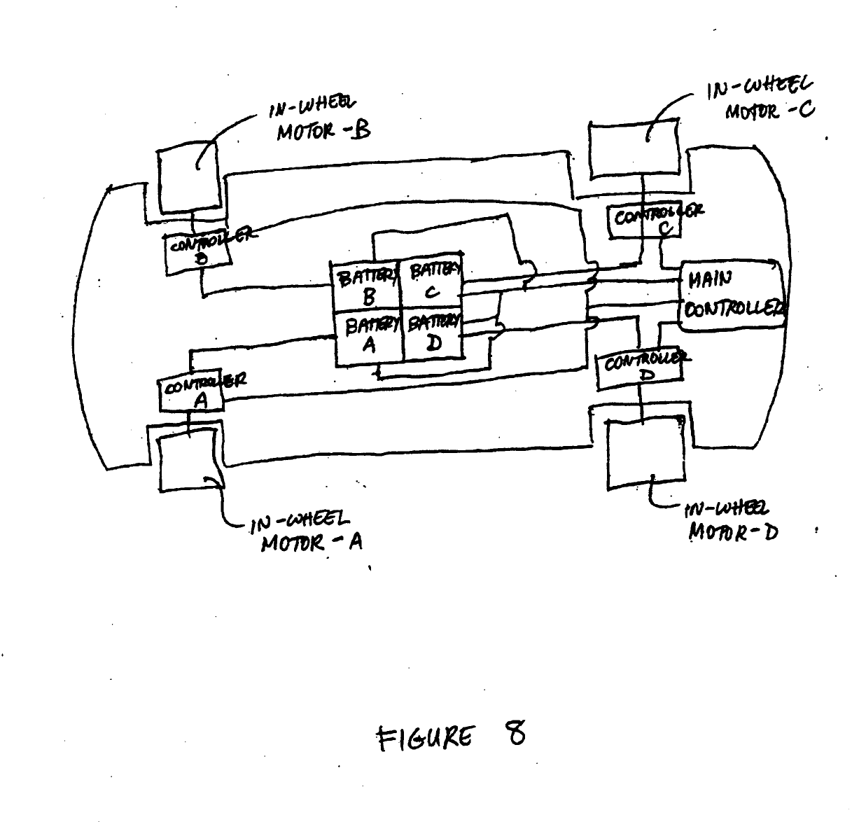

FIG. 8 shows an example of an electric car in accordance with the present invention with four motors and four batteries/controls.

The present invention can be described in many different ways. One example is an electric motor, generator or other electric machine where each electromagnetic circuit (or “phase”) of the machine has a separate set of power electronics that has no electrical connection with any other set of power electronics.

Another example in accordance with the present invention is an electric machine, as described in the above paragraph, where each electromagnetic circuit (or “phase”) of the machine has a separate power source that has no electrical connection with any other power source.

Another example in accordance with the present invention is an electric motor where the total power of the motor is greater than the square root of three times the voltage of the motor multiplied by the highest current flowing through any individual electromagnetic circuit of the motor.

Other examples in accordance with the present invention come in the form of an adaptive electric car or other electric vehicle with an electric propulsion system comprising two or more electric motors driving two or more wheels of the vehicle. In one example, the propulsion system provides at least 20 kilowatts peak power. The peak current for any electromagnetic circuit (or “phase”) of each motor is less than 300 amps.

Another example in accordance with the present invention—for the same kind of adaptive electric car or other electric vehicle—comes when the propulsion system provides at least 20 kilowatts peak power. The system voltage of the propulsion system is 50 volts or less. The peak current for any electromagnetic circuit (or “phase”) of each motor is less than 300 amps.

Another example in accordance with the present invention—for the same kind of adaptive electric car or other electric vehicle—comes when the system voltage of the propulsion system is 50 volts or less. The ratio of the peak power of the propulsion system to the peak per-phase current for each electromagnetic circuit (or “phase”) of each motor is greater than 100 watts per amp.

1. An electric machine comprising an electromagnetic circuit having separate sets of power electronics that are absent any electrical connection with any other set of power electronics.

2. The machine of claim 1 where each electromagnetic circuit of the machine has a separate power source that has no electrical connection with any other power source.

3. An electric motor where the total power of the motor is greater than the square root of three times the voltage of the motor multiplied by the highest current flowing through any individual electromagnetic circuit of the motor.

4. An adaptive electric car or other electric vehicle with an electric propulsion system comprising two or more electric motors driving two or more wheels of the vehicle, wherein the propulsion system provides at least 20 kilowatts peak power, and where the peak current for any electromagnetic circuit of each motor is less than 300 amps.

5. An adaptive electric car or other electric vehicle with an electric propulsion system comprising two or more electric motors driving two or more wheels of the vehicle, wherein the propulsion system provides at least 20 kilowatts peak power, where the system voltage of the propulsion system is 50 volts or less, and wherein the peak current for any electromagnetic circuit of each motor is less than 300 amps.

6. An adaptive electric car or other electric vehicle with an electric propulsion system comprising two or more electric motors driving two or more wheels of the vehicle, wherein the system voltage of the propulsion system is 50 volts or less, and wherein the ratio of the peak power of the propulsion system to the peak per-phase current for each electromagnetic circuit of each motor is greater than 100 watts per amp.
